(19) United States
(12) Patent Application Publication
(10) Pub. No.: US 2015/0195674 A1
(43) Pub. Date: Jul. 9, 2015

(54) METHOD FOR ESTIMATING DELAY DIFFERENCE BETWEEN RECEIVE PROCESSING CHAINS OF A DEVICE USING CROWD SOURCING

(71) Applicant: QUALCOMM Incorporated, San Diego, CA (US)

(72) Inventors: Guttorm R. OPSHAUG, Redwood City, CA (US); Benjamin A. WERNER, Sunnyvale, CA (US); Grant Alexander MARSHALL, Campbell, CA (US); Weihua GAO, San Jose, CA (US)

(73) Assignee: QUALCOMM Incorporated, San Diego, CA (US)

(21) Appl. No.: 14/149,524

(22) Filed: Jan. 7, 2014

(51) Int. Cl. H04W 4/02; G01S 5/02; H04W 56/00

(52) U.S. Cl. CPC H04W 4/02; H04W 56/0015; G01S 5/02; H04W 88/02

(57) ABSTRACT

Systems, methods, and devices are described for estimating delay difference between two receive chains of a mobile device. The mobile device receives a first signal from a base station using a first receive chain, and receives a second signal using a second receive chain from a common, remote timing source for the base station and the mobile device. In addition, the mobile device obtains a transmit delay parameter associated with the base station and estimates, based at least in part on the transmit delay parameter, an offset value corresponding to a difference between amount of time for the first signal to pass through the first receive chain of the mobile device and amount of time for the second signal to pass through the second receive chain of the mobile device. The mobile device may store the offset value for subsequent use in estimating its position.

### TECHNICAL FIELD

The present disclosure relates generally to wireless communications, and more particularly, to estimating delay difference between two or more receive chains in a device.

### BACKGROUND

Position of a mobile device, such as a cellular telephone, smart phone, etc., may be estimated based on information gathered from various systems. One such system may comprise a Global Navigation Satellite System (GNSS), which is one example of a satellite positioning system (SPS). SPS systems may include a number of space vehicles (SV) orbiting the earth. Another example of a system that may provide a basis for estimating the position of a mobile device is a cellular communication system including a number of base stations that communicate with a number of mobile devices. Yet another example is a wireless local area network (WLAN) system including a number of access points (APs) that communicate with a number of mobile devices.

A position estimate, which may also be referred to as a position “fix”, for a mobile device may be obtained based at least in part on distances or ranges from the mobile device to one or more transmitters, and also based at least in part on the locations of the one or more transmitters. As an example, such transmitters may comprise SVs in the case of an SPS and/or terrestrial base stations in the case of a cellular communications system. Ranges to the transmitters may be estimated based on signals transmitted by the transmitters and received at the mobile device. The location of the transmitters may be ascertained, in at least some cases, based on the identities of the transmitters, and the identities of the transmitters may be ascertained from signals received from the transmitters.

A number of cellular communications systems, such as the cellular systems in compliance with the long term evolution (LTE) standard, include base stations that are synchronous with an external source such as SPS. Given that the time of transmission of signals from the base stations are known, powerful range-based hybrid positioning techniques may become possible. However, two parameters may be needed in order to precisely perform range-based hybrid positioning techniques.

The first parameter may be a transmission delay corresponding to each transmitter caused by hardware, cables and the like. The second parameter may be the delay difference between different receive processing chains (e.g., SPS and cellular network radio frequency (RF) processing chains) at the receiver. In general, the transmitter delay should be estimated for each base station and/or transmitter. Similarly, the delay difference between different receive chains is specific to each device, and should be estimated/measured for each device. However, estimating these parameters for each receiver (e.g., mobile device) and/or each transmitter (e.g., base station) is costly. Therefore, there is a need in the art for efficient methods for estimating delay difference between different processing chains of a receiver and/or estimating transmission delay of a transmitter.

### SUMMARY

Certain embodiments present a method for wireless communications that may be performed by a mobile device. The method includes, in part, receiving a first signal using a first receive chain of the mobile device, wherein the first signal is received from a base station, receiving a second signal using a second receive chain of the mobile device, wherein the second signal is received from a common, remote timing source for the base station and the mobile device, obtaining a transmit delay parameter associated with the base station, estimating, based at least in part on the transmit delay parameter, an offset value corresponding to a difference between amount of time for the first signal to pass through the first receive chain of the mobile device and amount of time for the second signal to pass through the second receive chain of the mobile device, and storing the offset value for subsequent use in estimating position of the mobile device.

In one embodiment, the first receive chain is in compliance with the LTE and the second receive chain is in compliance with GNSS. In one embodiment, the transmit delay parameter is determined by a device and supplied to the mobile device. An offset between time of arrival of signals from the first receive chain and the second receive chain may be known for the device.

One embodiment includes, in part measuring a time of arrival of the first signal, obtaining a time of transmission of the first signal from the base station, and estimating the offset value using the time of arrival of the first signal, the time of transmission of the first signal from the base station, time of propagation of the first signal from the base station, and the transmit delay parameter.

In one embodiment an estimated position of the mobile device is obtained and the offset value is estimated based at least on the estimated position. As an example, the estimated position is derived based on communications with one or more wireless local area network base stations. The position can also be derived using a Kalman filter.

In one embodiment, the mobile device communicates with an additional base station using the first receive chain to determine an additional transmit delay parameter corresponding to the additional base station based at least in part on the estimated offset value corresponding to the first receive chain. The mobile device may then transmit the second delay parameter.

Certain embodiments provide an apparatus for wireless communications. The apparatus includes, in part, a first receive chain for receiving a first signal, wherein the first signal is received from a base station, a second receive chain for receiving a second signal, wherein the second signal is received from a common, remote timing source for the base station and the apparatus. The apparatus further includes, in part, a circuit for obtaining a transmit delay parameter associated with the base station, and an estimator for estimating, based at least in part on the transmit delay parameter, an offset value corresponding to a difference between amount of time for the first signal to pass through the first receive chain of the apparatus and amount of time for the second signal to pass through the second receive chain of the apparatus. The apparatus further includes a memory for storing the offset value for subsequent use in estimating position of the apparatus.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example wireless communication network, in accordance with certain embodiments of the present disclosure.

FIG. 2 illustrates an example block diagram of a mobile device communicating with a satellite and a base station, in accordance with certain embodiments of the present disclosure.

FIG. 3 illustrates an example timing diagram corresponding to a signal transmitted from a transmitter to a receiver, in accordance with certain embodiments of the present disclosure.

FIG. 4 illustrates example operations that may be performed by a device to estimate delay difference between two receive chains, in accordance with certain embodiments of the present disclosure.

FIG. 5 illustrates example steps that may be performed by a device to calibrate its receive chains, in accordance with certain embodiments of the present disclosure.

FIG. 6 illustrates example steps that may be performed by a server to determine position of a device, in accordance with certain embodiments of the present disclosure.

FIG. 7 describes one potential implementation of a device which may be used to estimate group delay calibration value, according to certain embodiments.

### DETAILED DESCRIPTION

In order to perform range-based positioning with high accuracy in a terrestrial network (e.g., cellular network, wireless local area network (WLAN), and the like), delay parameters corresponding to different transmitters and/or receivers in the network should be known. These delay parameters can either be measured directly for each device (which is very costly), or be estimated in the field, according to one embodiment. In general, cables, processing hardware and other elements in transmit/receive chain of a device may cause certain amount of delay, which is specific to each device. On the other hand, range-based positioning techniques rely on measuring time of travel of signals between transmitter and receiver devices. The delay in cables and/or processing hardware in the transmitter/receiver devices may result in error in the estimated position, if not accounted for.

As used herein, the term “base station” includes any wireless communication station and/or device, typically installed at a fixed terrestrial location and used to facilitate communication in a wireless communications system. For example, a base station may comprise a wireless local area network (WLAN) access point, Macro cell, Macro base station, Pico cell, Pico base station, Femto cell, Femto base station, eNode B, Node B, or the like.

As used herein, the term “mobile device” refers to a device that may from time to time have a position location that changes. For example, a mobile device may comprise a cellular telephone, wireless communication device, user equipment, laptop computer, a personal communication system (PCS) device, personal digital assistant (PDA), personal audio device (PAD), portable navigational device, and/or other portable communication devices.

As used herein, the term SPS is used to refer to any regional and/or global satellite positioning systems, or a combination of different satellite positioning systems, although the scope of claimed subject matter is not limited in this respect. In some embodiments, SPS satellites may be from a global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one of several regional navigation satellite systems (RNSS) such as, for example, WAAS, EGNOS, QZSS, to name a few examples.

In a cellular network including mobile devices and base stations, causes of differences in time of arrival of different signals at a mobile device are ambiguous, even when positions of the base stations and the mobile device are known. In general, a transmitter time offset and a radio frequency (RF) processing delay are added to every measurement corresponding to time of arrival of signals at the receiver. However, these parameters should be estimated separately in order to correctly subtract them from the measurements performed by each of the devices (e.g., a base station and a mobile device).

Certain embodiments estimate one or more calibration parameters (e.g., delay difference between different receive chains, transmit time offset, etc.) of one or more devices in a network, and spread the estimated parameters in the network. The estimated calibration parameters may be used by other devices in the network to calibrate their own transmit/receive chains. In one embodiment, a network may include a plurality of wired and/or wireless devices. In general, each of the plurality of devices may be mobile (e.g., a cell phone, laptop) or fixed (e.g., a base station).

In one embodiment, one or more of pseudo-range measurements and/or accuracy level position/velocity/time (PVT) fixes in SPS, time of arrival of positioning reference signals from different base stations, or other similar signals/measurements may be used to estimate the calibration parameters. As an example, the base stations in a cellular network may be synchronized with an external source, such as satellites and/or space vehicles of a SPS system. Using the common timing source, information from one or more devices can be analyzed to estimate calibration parameters of devices in the field. For example, transmit time offset of one or more base stations and/or receiver delay difference between SPS processing and cell network processing chains of one or more mobile devices can be estimated, using the methods described herein.

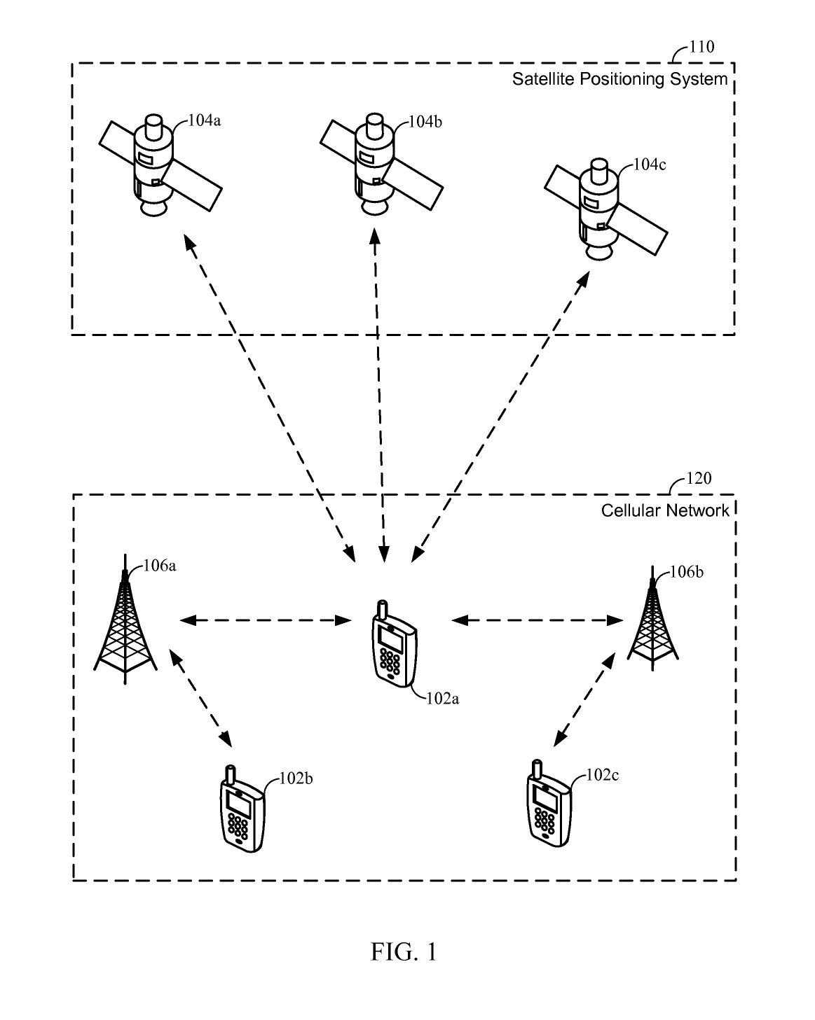

FIG. 1 illustrates an example satellite positioning system 110 and a cellular network 120 in communication with a mobile device, in accordance with certain embodiments of the present disclosure. Satellite positioning system 110 may comprise a number of space vehicles (SVs), for example SVs 104a. 104b, and 104c. The satellite positioning system (SPS) 110 may comprise one or more satellite positioning systems, such as GPS, GNSS, and/or Galileo, and the like. Mobile devices 102a, 102b, and 102c may receive signals from one or more of SVs 104a, 104b, and 104c, and may communicate with one or more base stations 106a and/or 106b.

Cellular network 120 may provide voice and/or data communication for a number of mobile devices including mobile device 102a, for example, and may further support position estimation for the mobile devices in addition to providing voice/data service. Cellular network 120 may comprise any of a number of cellular network types (such as CDMA, LTE, WiMAX, and the like). Cellular network 120 may include base stations 106a and 106b that provide communication for a number of wireless terminals such as, mobile devices 102a-102c. In one embodiment, the base stations may be synchronized with a common timing source. For example, the base stations may be synchronous with SPS signals received from one or more SVs 104.

For simplicity, only two base stations 106a and 106b and only three mobile devices are depicted in FIG. 1. However, other examples may include any number of mobile devices and or base stations. Also, cellular network 120 is merely an example wireless communications system, and the scope of claimed subject matter is not limited in this respect.

In one example, mobile device 102a may obtain one or more measurements from one or more signals received from one or more of the SVs and/or base stations. Mobile device 102 may calculate a position location for itself based, at least in part, on timing calibration parameters received through communication with one or more of base stations 106a and 106b, and further based, at least in part, on known position locations of the base stations. The mobile device may also make use of an estimated propagation delay for signals received from a base station source, a satellite source, or both.

In an embodiment, a network entity such as, for example, a location server (not shown), may receive information from different devices in the network and determine position of different devices. Such a determination may be based, at least in part, on information gathered by mobile device 102 from one or more of base stations 106a and 106b and/or SVs. The location server may transmit the calculated position location and other parameters to mobile device 102.

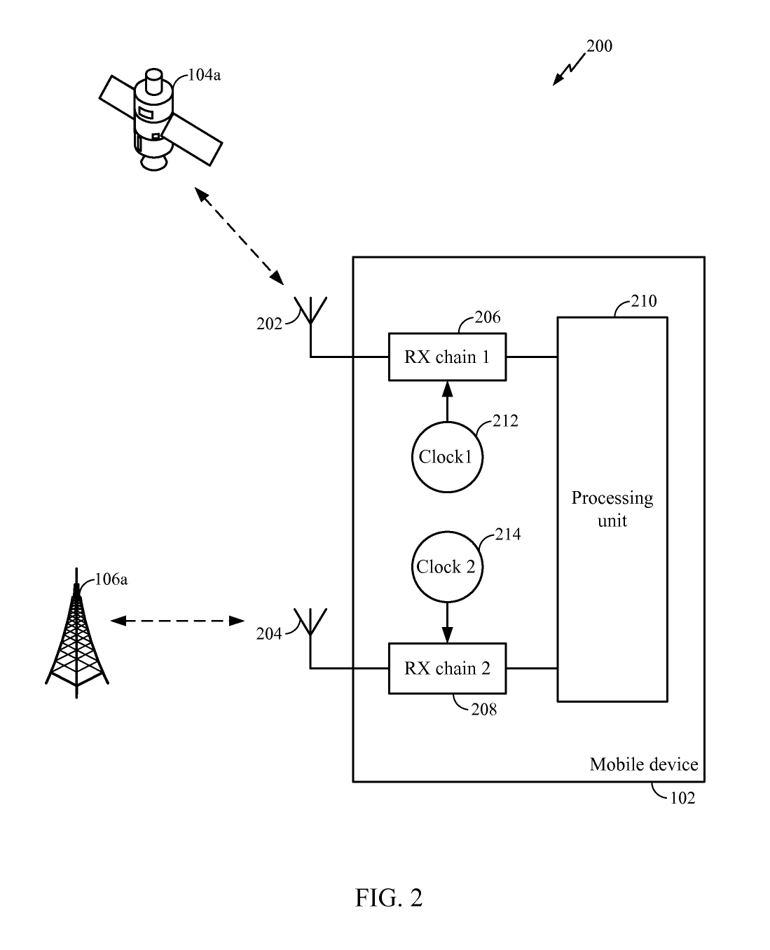

FIG. 2 illustrates an example block diagram of a mobile device 102 communicating with one or more SVs and/or base stations, in accordance with certain embodiments of the present disclosure. For simplicity, only one SV 104a and one base station 106a is illustrated in FIG. 2, however, the mobile device may communicate with any number of devices (SVs, base stations, other mobile devices) without departing from teachings of the present disclosure. Mobile device 102 receives signals from SV 104a through receive antenna 202, and processes the signal with receive (RX) chain 206, before sending the received signal to the processing unit 210 for further processing. Similarly, mobile device 102 receives signals from base station 106a through receive antenna 204, and processes the signal with RX chain 208, before sending the received signal to the processing unit 210 for further processing. Although two antennas are illustrated in FIG. 2, the mobile device may include any number of antennas (e.g., one or more antennas). In an example, the two receive chains 206 and 208 may be connected to a single antenna (not shown) and receive signals either in different time frames (e.g., using time division duplex) or different frequencies (e.g., using frequency division duplex).

In one embodiment, each of the receiver chains may operate with a different reference clock. For example, RX chain 206 may use reference clock 212 and RX chain 208 may use reference clock 214. In one embodiment, clock 212 may be synchronized with clock 214 or vice-versa. In another embodiment, the two RX chains may share the same reference clock (not shown).

It should be noted because of cables and other processing hardware in each receive chain, there might be a delay between the time that a signal appears at a receive antenna (e.g., antenna 204) and the time that the signal is received and time-stamped in the RX chain (e.g., 208). In addition, the mobile device receives clock synchronization signals from SV 104a to synchronize its internal clocks 212 and/or 214. There might be a time difference (e.g., delay) between the time that a signal (e.g., that is transmitted by SV 104a) is received at the receive antenna 202 and the time that the signal is received and time-stamped at the RX chain 206. In one embodiment, it may not be necessary to find the absolute values of each of the delays in the RX processing chains. In one embodiment, for precise positioning techniques, a group delay calibration between the two RX processing chains may suffice.

Similarly, there might be a delay (e.g., transmit time offset) between the time that a signal is time-stamped by a transmit chain of a transmitter (e.g., time of transmission), and the time that the signal actually leaves the transmit antenna of the transmitter. This transmission delay may be caused by long cables and other processing elements in the transmitter.

### Determining Group Delay Calibration and Transmit Time Offset Values

Certain embodiments describe methods for calibrating different receiver chains in a device (e.g., mobile or fixed) and/or calibrating a transmitter chain in a transmitter. In this document, group delay calibration refers to time calibration of the group delay offset between two receiver chains in the device. In one embodiment, the device may use a first receiver chain (e.g., RX chain 206) for receiving SPS signals and a second receiver chain (e.g., RX chain 208) for receiving LTE signals. In this case, group delay calibration refers to determining group delay difference between the signal path receiving LTE signal and the signal path receiving the SPS signal.

In another embodiment, the device may use two different receiver chains to receive different SPS signals. The methods described herein may be used to determine group delay difference between any two receive chains. In general, each of the receiver chains may operate in compliance with any wired and/or wireless technologies, such as LTE, SPS, and the like.

In addition, methods are described for determining transmit time offset of a transmit chain of a transmitter. As described before, the transmit time offset may refer to the time that takes for a signal to pass through a transmit chain of a transmitter (e.g., through different hardware and cables) before being transmitted by a transmit antenna.

In one embodiment, one or more transmit time offset values may be calculated for each device corresponding to one or more transmit antennas and/or transmit chains. In case of a base station, it may be assumed that the transmit time offset values corresponding to different cells served by the base station are similar. This might be true for tower-mounted base stations. However, the transmit time offset for different cells in building-mounted base stations may be different. Therefore, in one embodiment, different transmit time offset values may be calculated for different cells and/or transmit chains corresponding to a base station.

According to one embodiment, a class of devices used in a network may be calibrated, which could serve to help another class of devices that are not calibrated. Without loss of generality, it can be assumed that at least one device exists in a network, for which calibration information (e.g., group delay difference between two receive chains and/or transmit time offset) is known. As an example, transmit and/or receive chains of the at least one device can be calibrated (e.g., in the factory, in a lab and/or using any other method). In one embodiment, Femto base stations may be used as reference devices with calibrated transmit and/or receive chains. In one embodiment, the calibrated device can be a mobile device for which an offset between SPS and cellular network time of arrivals is known. Using the calibrated mobile device, one or more measurements may be made while communicating with a base station. Using the one or more measured values, a base station transmit time offset can be estimated, which can then be used to determine other calibration values for other mobile devices that communicate with the calibrated base station. In one embodiment, timing information can spread from any base station to any mobile device for which range measurements and/or calibration is being performed.

In another embodiment, the calibrated device can be a Femto station for which an offset between receiver chains corresponding to SPS and cellular network are known. The Femto station may measure time of arrival of one or more signals received from a base station. Using the one or more measured values, a base station transmit time offset can be estimated, which can then be used to obtain other calibration values for other mobile devices that communicate with the calibrated base station. In one embodiment, values of parameters in the network may be updated over time corresponding to any changes in the network.

According to one embodiment, a navigation equation may be used for communication between two devices, as follows:

TOAuᵤ₁⁽¹⁾=TOT⁽¹⁾+B⁽¹⁾+dᵤ₁⁽¹⁾+Δᵤ₁ Eqn (1)

where TOAᵤ₁⁽¹⁾ may represent the observed time of arrival of a signal S1 transmitted by cell 1 as observed by a user u1 in a common system time (e.g., SPS time), TOT⁽¹⁾ may represent the ideal/desired time of transmission of the signal from cell 1 in common system time (e.g., SPS time), B⁽¹⁾ is the time offset of cell 1's actual transmission time with respect to the desired time of transmission. In one embodiment, the transmit time offset of a transmitter may be considered as a negative of the B⁽¹⁾ offset. In addition, dᵤ₁⁽¹⁾ may represent the time that takes for a signal to travel the distance between cell 1 and user u1 (e.g., time-of-flight). Moreover, Δᵤ₁ may represent the difference in group delay between two different receiver paths (e.g., SPS and LTE receive chains). In one embodiment, group delay calibration may be considered to be equal to −Δᵤ₁.

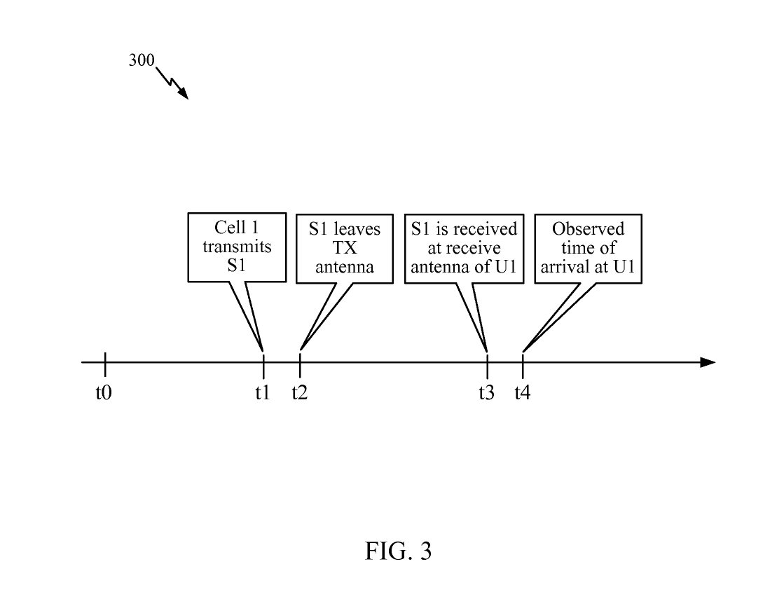

FIG. 3 illustrates an example timing diagram corresponding to a signal transmitted from a transmitter to a receiver, in accordance with certain embodiments of the present disclosure. As illustrated, a transmitter (e.g., a base station) transmits signal S1 at time t1. Because of the delay in the cable and other hardware in the transmitter chain, signal S1 leaves the transmit antenna of the transmitter at time t2. In this example, t2−t1 is equivalent to B⁽¹⁾. Signal S1 travels through the air and is received at the receive antenna of receiver u1 at time t3. Therefore the time of flight dᵤ₁⁽¹⁾=t3−t2. Because of the cable and hardware delay in the receive chain, the signal S1 is observed at the receiver at time t4.

Referring to FIG. 2, if the clock in the receive chain (e.g., RX chain 204) is synchronized with a remote timing source (e.g., SPS clock), every time-stamp at the receiver may be delayed by the time that takes for signal to pass through receive antenna 202, cables and other hardware, before being received by the RX chain 206.

For a network, including N mobile devices (e.g., u₁ through u_{N}) that are communicating with a base station, the following equation set may be derived based on Eqn (1).

TOAᵤ₁⁽¹⁾=TOT⁽¹⁾+B⁽¹⁾+dᵤ₁⁽¹⁾+Δᵤ₁

TOAᵤ₂⁽¹⁾=TOT⁽¹⁾+B⁽¹⁾+dᵤ₂⁽¹⁾+Δᵤ₂

TOA_{uN}⁽¹⁾=TOT⁽¹⁾+B⁽¹⁾+d_{uN}⁽¹⁾+Δ_{uN}

If group delay calibration values are unknown for all of the users (which is generally different for each user), then cell position and transmit time offset value cannot be found. The reason is that the above set of equations gets a new unknown for every new measurement. However, according to one embodiment, if group delay difference is unknown, but common for all users (e.g., Δ), then transmit time offset (O) becomes biased by the common group delay difference value, as follows:

O⁽¹⁾=−(B⁽¹⁾+Δ)

Similarly, in one embodiment, if one user (e.g., u1) records multiple observations of the same cell, group delay calibration value would be common for the measurement set. Therefore, the resulting estimate of transmit time offset may become similarly biased by Δᵤ₁.

### In-The-Field Group Delay Calibration Estimation

According to one embodiment, if a mobile device (e.g., u1) observes multiple base stations (e.g., A, B, C, . . . ), the following equations may be considered corresponding to each of the base stations:

TOA_{u1,A}⁽¹⁾=TOT⁽¹⁾+B⁽¹⁾+d_{u1,A}⁽¹⁾+Δᵤ₁

TOA_{u1,A}⁽²⁾=TOT⁽²⁾+B⁽²⁾+d_{u1,A}⁽²⁾+Δᵤ₁

TOA_{u1,A}^{(N)}=TOT^{(N)}+B^{(N)}+d_{u1,A}^{(N)}+Δᵤ₁

If locations of the mobile device and the base stations are known, d_{u1,A}⁽¹⁾ may be known in each of the above equations. Hence, group delay calibration value Cᵤ₁ for the mobile device may be estimated as follows:

$${C}_{u 1} = - ( {Δ}_{u 1} + \frac{{\sum }_{i = 1}^{N} {B}^{( i )}}{N} )$$

In one embodiment, with enough diverse cell observations and assuming cell clock biases are independent and identically distributed (iid) with close to zero bias and variance of σ², the value of Cᵤ₁ may converge to −Δᵤ₁ with variance of

$$\frac{{σ}^{2}}{N} .$$

However, this assumption may easily be broken in practice, where it is more likely to have other delays (e.g., due to cable biases, etc.) be included in time of transmission.

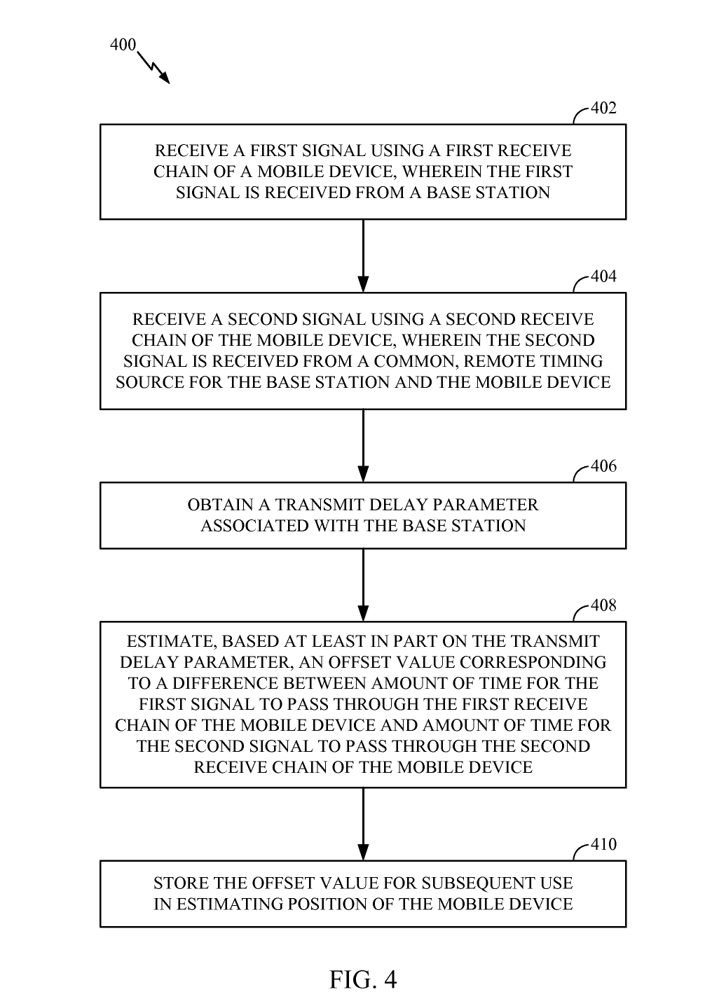

FIG. 4 illustrates example operations that may be performed by a device (e.g., a mobile or fixed) to estimate one or more offset values. At 402, the device receives a first signal using a first receive chain from a base station. At 404, the device receives a second signal using a second receive chain from a common, remote timing source for the base station and the device. As an example, the first receive chain receives an LTE signal from a base station and the second receive chain receives a SPS signal from a satellite or SV. In general, the first and the second receive chains may correspond to similar or different technologies without departing from the teachings of the present disclosure. In one embodiment, both receive chains may receive SPS signals.

At 406, the device obtains a transmit delay parameter associated with the base station (e.g., a transmit time offset value corresponding to transmit chain of the base station). In one embodiment, the transmit delay parameter may be determined by another device (e.g., another mobile device, a Femto base station, a location server, and the like) and be passed to the device.

At 408, the device estimates, based at least in part on the transmit delay parameter, an offset value corresponding to a difference between amount of time for the first signal to pass through the first receive chain of the device and amount of time for the second signal to pass through the second receive chain of the device. In one embodiment, the device obtains an estimate of its position and determines the offset value based at least on the estimated position. At 410, the device stores the offset value for subsequent use in estimating position of the device. As an example, the device performs the above steps at a known location to determine the offset value (e.g., calibrate its receive chains). The device may then store the offset value in its memory and moves to other locations. The device may then use the stored offset value when estimating its new position.

In one embodiment, the device measures time of arrival of the first signal and estimates the offset value by obtaining time of transmission of the first signal from the base station. The device may estimate the offset value using the time of arrival of the first signal, the time of transmission of the first signal from the base station, time of propagation of the first signal from the base station, the transmit delay parameter and other parameters.

In one embodiment, after the device is calibrated, the device may communicate with an additional base station using the first receive chain to determine an additional transmit delay parameter corresponding to the additional base station based at least in part the estimated offset value corresponding to the first receive chain. The device may then transmit information regarding the second delay parameter to other devices in the network. In one embodiment, a position server may store the one or more of the determined offset values and/or transmit delay parameters corresponding to different devices in the network.

### Group Delay Calibration

In general, several methods may be used to determine group delay calibration values between different receive chains and calibrate a device. One method would be to measure parameters corresponding to each individual device and calibrate the device based on the measurements. As an example, each device may be calibrated in the factory. This device-specific calibration method may have the best calibration performance with the best confidence on the calibration values. However, device-specific calibration is very costly for the original equipment manufacturers (OEMs). Different group delay calibration values should be determined for different receive chains, which may operate in different frequency bands. Therefore, in order to calibrate a mobile station that has an LTE receive chain and a SPS receive chain, both SPS and LTE simulators may be needed on the factory floor. Considering that millions of mobile devices are manufactured, calibrating each individual device may significantly increase production cost.

According to one embodiment, another method for estimating group delay calibration values may be based on device characterization. Device characterization refers to determining one or more parameters that are typical for a given device model. In this case, each model of devices may be tested and characterized by a sparse sampling of devices. For example, instead of calculating calibration parameters for each device (in the order of millions of devices), a few devices (e.g., 10-20 devices) in each model may be tested. In this way, average parameters corresponding to the specific device model may be determined.

It should be noted if devices have a large ensemble spread, the characterized values will have higher uncertainty and lower confidence. The ensemble spread may represent a measure of the difference between a certain parameter (e.g., group delay calibration value) in different individual devices in a set of devices (e.g., a device model). On average, a small ensemble spread correspond to a high characterization accuracy and a large ensemble spread corresponds to a low characterization accuracy. In general, there is an uncertainty in the ensemble spread of group delay calibration value over a production run. There is even higher uncertainty of ensemble spread over multiple production runs with potentially different stock keeping units (SKUs) and components.

It should be noted that ensemble deviation for group delay calibration for advance forward link trilateration (AFLT) may be in the order of several hundreds of nanoseconds. In one embodiment, a server may determine transmit time offset values corresponding to different base stations based on the characterized values.

In one embodiment, device characterization may be performed by a device manufacturer. However, the manufacturer may still need simulators for different receive chains (e.g., LTE and SPS) and may need to perform procedures as mentioned for the device-specific calibration. Although device characterization can be performed with significantly less effort than the device-specific calibration. Device characterization may be performed either in a lab, or in a factory floor. A manufacturer may upload and store the calibration parameter in non-volatile memory on all devices with the characterization parameter. This enables measurement compensation on each device without having any impact on the upload structures or data in a network. In one embodiment, the manufacturer may send these information to a third party. The manufacturer may add unique OEM and model number (ideally production number and SKU) to be stored on each device, which can be uploaded to a server.

In one embodiment, mobile characterization could be done by a third party. For example, at least one copy of every single device model that uses specific WWAN/SPS chips may be provided to the third party. Ideally, one or more devices may be provided for each production run. This method may use unique OEM and model number (e.g., production number and SKU) that are stored on the device and are uploaded to the server. Similar to the previous case, characterization compensation may be done on a server.

In another method, according to one embodiment, calibration parameters may be estimated in the field. As described before, the calibration parameters for each device may be estimated in the field by averaging transmit time offset values from a number of observed wireless wide area network (WWAN) cells. This method may use a priori knowledge of cell locations (e.g., base station almanac (BSA)). In addition, it may be assumed that transmit time offset values are close to zero with equal probability of negative and positive values. It should be noted that if a typical bias exists for an ensemble of cells, then the bias would become a common mode error for all devices and will have little impact on performance of the system.

In one embodiment, each device may observe a cell at multiple instances. The device may then process the measurements or send them to a server for processing. Therefore, storage space may be needed for the measured values on the device and/or on the server. In addition, some of the available bandwidth may be used to upload measurements. As a result, multiple measurement sets (e.g., position and WWAN measurements) may be generated by one or more devices for each serving cell. These measurements may be stored on the devices and/or uploaded to one or more servers for processing. In general, the user may not measure the signals received from neighboring cells. As an example, the user may receive information about transmit time offset values of the neighboring cells from a server or another device.

In one embodiment, a calibration parameter corresponding to a mobile device may be estimated in the field by camping on a cell for which transmit time offset is known. For example, the mobile device may camp on the base station and estimate the its corresponding calibration parameter (e.g., group delay difference between different receive chains) based on the known transmit time offset. The device may then visit other cells for which transmit time offset values are not known. In this way the device can help those cells to estimate their corresponding transmit time offset values, and thereby expand the coverage area. In this method, the transmit time offset estimation is “going viral”. The expanded coverage area will let even more devices estimate their corresponding calibration parameters which will lead to even more transmit time offset estimation and so on.

In one embodiment, a small subset of cells may be war-driven with a device for which calibration parameters are known. In one embodiment, reverse position and absolute transmit time offset estimation may be performed based on the known values. In this method position of one or more base stations and absolute transmit time offset values corresponding to one or more of the base stations may be determined, that may be used by other devices to determine their corresponding delay difference values.

It should be noted that one of the drawbacks of estimating calibration parameters in the field is error aggregation with each hop. For example, if the first transmit time offset value (e.g., the seed transmit time offset) is not accurate, the rest of the values that are calculated based on the seed transmit time offset value may have similar errors. Each time a new transmit time offset and/or group delay calibration value is calculated, errors or uncertainty in estimated values may grow.

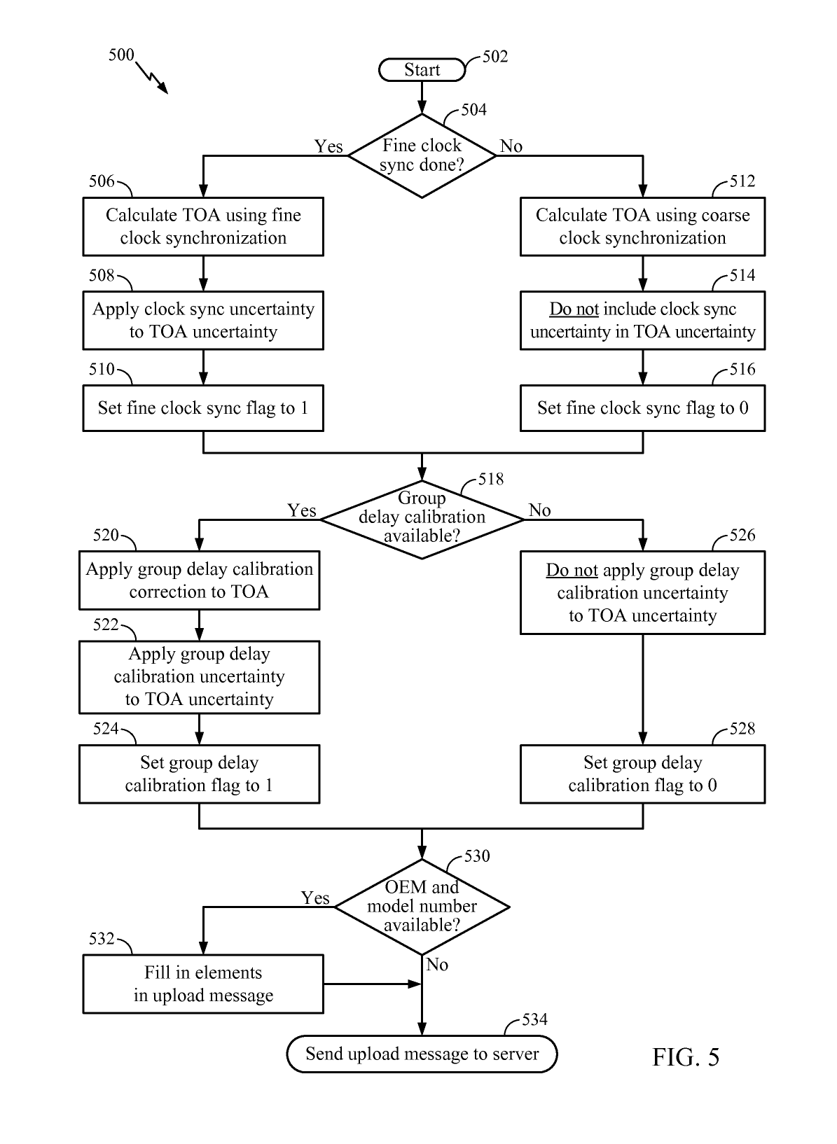

FIG. 5 illustrates example steps that may be performed by a mobile device to calibrate its receive chains, in accordance with certain embodiments of the present disclosure. At 504, the mobile device checks whether or not clock synchronization between two or more receive chains is previously performed. Referring to FIG. 2, the mobile device checks if clock 212 corresponding to RX chain 206 and clock 214 corresponding to RX chain 208 are synchronized.

In one embodiment, for accurate time of arrival (TOA)-based reverse positioning and absolute transmit time offset estimation, both fine clock synchronization and precise estimation of group delay calibration values may be performed. Fine clock synchronization may usually be a hardware-based approach with close to one nanosecond accuracy. On the other hand, coarse clock synchronization may have enough accuracy for extrapolating uncertainty in user position at time of arrival of WWAN signals. As an example, a user driving in a highway with a speed of 30 meters per second travels only 3 cm in 1 ms. Coarse clock synchronization can be software-based, with an accuracy in the order of tens of microseconds. It should be noted that coarse synchronization may not have enough certainty for TOA-based reverse positioning and absolute transmit time offset estimation.

If the clocks are synchronized, at 506, the mobile device calculates TOA using a fine clock synchronization method. At 508, the mobile device updates an uncertainly parameter (e.g., uncertainty of the TOA) based on uncertainty in the clock synchronization between the two receive chains and sets a flag to indicate that fine clock synchronization has been performed (e.g., sets fine clock synchronization flag to one) (at 510).

In one embodiment, if fine clock synchronization between the receive chains is not done, at 512, the mobile device calculates TOA using coarse clock synchronization methods. In this case, at 514, the mobile device does not include uncertainty of clock synchronization in TOA uncertainty. At 516, the mobile device sets fine clock synchronization flag to zero to notify a location server of its clock synchronization status.

At 518, the mobile device checks whether or not delay difference between two receive chains is available. If the delay difference is available, at 520, the mobile device applies correction of the delay difference value to TOA-based positioning. In addition, at 522, the mobile device applies uncertainty of the estimated delay difference value to TOA uncertainty and sets a group delay calibration flag to one (at 524). If the delay difference between two receive chains is not available, the mobile device does not apply group delay calibration uncertainty to TOA uncertainty, and sets group delay calibration flag to zero (at 528). At 530, the mobile device checks if it has knowledge about its OEM and model number. If values of OEM and model number are available, at 532, the mobile device generates an upload message with these elements. At 534, the mobile device sends the upload message to the server.

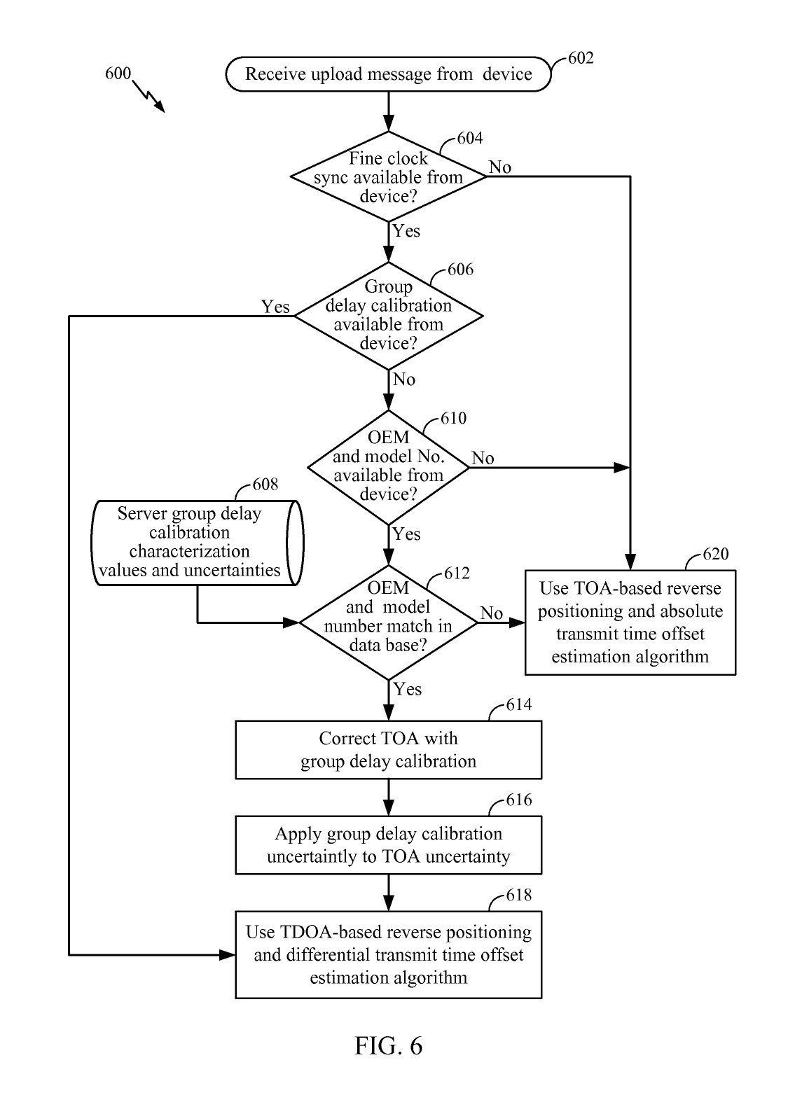

FIG. 6 illustrates example steps that may be performed by a server to determine position of a mobile device, in accordance with certain embodiments of the present disclosure. At 602, the server receives an upload message from a mobile device. At 604, the server checks if fine clock synchronization information is available in the upload message received from the mobile device. If yes, at 606, the server checks if the delay difference value between two receive chains of the mobile device is available. If the server knows the delay difference between the two receive chains of the mobile device, at 618, the server performs time of arrival-based reverse positioning and absolute transmit time offset estimation algorithm. If the delay difference value is not available from the mobile device, at 610, the server checks if OEM and model number of the mobile device are known. The server may have a database of the group delay calibration characterization values and uncertainties (608). The server may check to see if any information is available in the database corresponding to the OEM and model number of the mobile device (612). At 614, the server uses characterization information about the mobile station and corrects the TOA with the group delay calibration value based on the characterized information. At 616, the servers applies uncertainty of the group delay calibration to TOA uncertainty and performs time of arrival-based reverse positioning and absolute transmit time offset estimation algorithm (at 618). If the server does not have any information about fine clock synchronization and/or OEM/model number, at 620, the server may use a time difference of arrival (TDOA)-based reverse positioning and differential transmit time offset estimation algorithm.

Operation with In-The-Field Transmit Time Offset Calibration

In one embodiment, TDOA-based reverse positioning may be performed in order to generate a list of base stations that are in vicinity of a device (e.g., a base station almanac (BSA)). For example, the BSA can be generated by a server and transmitted to different users (e.g., mobile and/or fixed devices).

In one embodiment, group delay calibration value may be determined before TOA-type upload commences. In one embodiment, group delay calibration value may be determined using observations from multiple base stations. For example, in one embodiment observations from nine or more different base stations may be used to estimate the group delay calibration value. In an example, assuming that different base stations are synchronized with the same clock, and have similar transmit time offset values, observations from different base stations may be used to estimate a group delay calibration value for a device.

Typically, different cells corresponding to a base station have different primary synchronization signals (PSS) and the same secondary synchronization signals (SSS). Therefore a device can infer whether or not the observations belong to the same cell/same base station based on the synchronization signals (e.g., SSS and/or PSS). In one embodiment, observations from each cell may be replaced over time if the total system error decreases (e.g., sum of position uncertainty, time uncertainty and measurement uncertainty decreases). For example, if uncertainty of the measurements decreases over time, group delay calibration values may be updated using the new observations.

In one embodiment, a first group delay calibration value may be estimated using a weighted average of the measurements, rejecting measurements corresponding to 3-sigma outliers, and recalculating a new weighted average. The estimated group delay calibration value may be used as a ‘seed’ to help estimate transmit time offset and/or group delay calibration value of other devices. In one embodiment, a single-sided filtering and/or weighting may be considered to compensate for an assumed positive bias in transmit time offset. In one embodiment, after seeding, moving average or infinite impulse response (IIR) filter may be performed along with outlier rejection on new cell measurements.

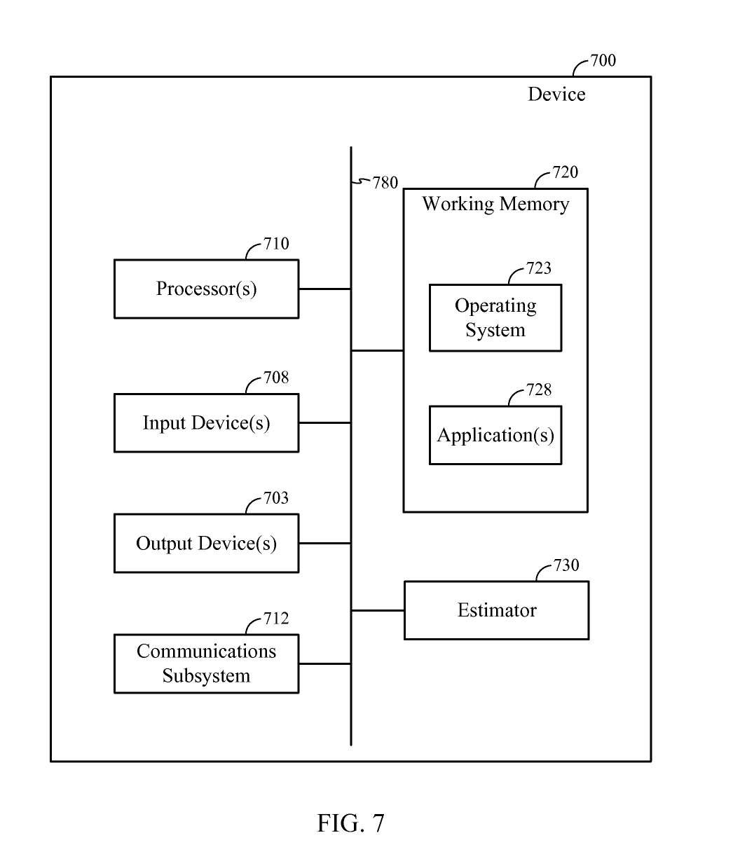

FIG. 7 describes one potential implementation of a mobile device which may be used to estimate group delay offset, according to certain embodiments. In one embodiment, device 102 as described in FIG. 2 may be implemented with the specifically described details of process 400. In the embodiment of device 700 shown in FIG. 7, specialized modules such as estimator 730 may estimate the group delay calibration value. These modules may be implemented to interact with various other modules of device 700. Memory 720 may be configured to store calibration information, and may also store settings and instructions regarding different positioning techniques, etc.

In the embodiment shown at FIG. 7, the device may be a mobile device or a location server and include processor 710 configured to execute instructions for performing operations at a number of components and can be, for example, a general-purpose processor or microprocessor suitable for implementation within a portable electronic device. Processor 710 may thus implement any or all of the specific steps for operating compression module as described herein. Processor 710 is communicatively coupled with a plurality of components within mobile device 700. To realize this communicative coupling, processor 710 may communicate with the other illustrated components across a bus 780. Bus 780 can be any subsystem adapted to transfer data within mobile device 700. Bus 780 can be a plurality of computer buses and include additional circuitry to transfer data.

Memory 720 may be coupled to processor 710. In some embodiments, memory 720 offers both short-term and long-term storage and may in fact be divided into several units. Short term memory may store data which may be discarded after an analysis, or all data may be stored in long term storage depending on user selections. Memory 720 may be volatile, such as static random access memory (SRAM) and/or dynamic random access memory (DRAM) and/or non-volatile, such as read-only memory (ROM), flash memory, and the like. Furthermore, memory 720 can include removable storage devices, such as secure digital (SD) cards. Thus, memory 720 provides storage of computer readable instructions, data structures, program modules, and other data for mobile device 700. In some embodiments, memory 720 may be distributed into different hardware modules.

In some embodiments, memory 720 stores a plurality of applications 728. Applications 728 contain particular instructions to be executed by processor 710. In alternative embodiments, other hardware modules may additionally execute certain applications or parts of applications. Memory 720 may be used to store computer readable instructions for modules that implement calibration and/or positioning according to certain embodiments, and may also store calibration information as part of a database.

In some embodiments, memory 720 includes an operating system 723. Operating system 723 may be operable to initiate the execution of the instructions provided by application modules and/or manage other hardware modules as well as interfaces with communication modules 712 which may use a wireless transceiver and a link. Operating system 723 may be adapted to perform other operations across the components of mobile device 700, including threading, resource management, data storage control and other similar functionality.

In some embodiments, mobile device 700 includes a plurality of other hardware modules (e.g., estimator 730). Each of these hardware modules is a physical module within mobile device 700. As an example, the estimator 730 may be configured to estimate calibration information as described herein.

In certain embodiments, a user may use a user input module 708 to select how to analyze the heat maps. Mobile device 700 may include a component such as a wireless communications module 712 which may integrate an antenna and wireless transceiver with any other hardware, firmware, or software necessary for wireless communications. Such a wireless communication module may be configured to receive signals from various devices such as data sources via networks and base stations such as a network base station. In certain embodiments, calibration information and/or OEM and model number information may be communicated to server computers, other mobile devices, or other networked computing devices to be stored in a remote database and used by multiple other devices when the devices execute positioning functionality

In addition to other hardware modules and applications in memory 720, mobile device 700 may have a display output 703 and a user input module 708. Display output 703 graphically presents information from mobile device 700 to the user. This information may be derived from one or more application modules, one or more hardware modules, a combination thereof, or any other suitable means for resolving graphical content for the user (e.g., by operating system 723). Display output 703 can be liquid crystal display (LCD) technology, light emitting polymer display (LPD) technology, or some other display technology. In some embodiments, display module 703 is a capacitive or resistive touch screen and may be sensitive to haptic and/or tactile contact with a user. In such embodiments, the display output 703 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

What is claimed is:

1. A method for wireless communications comprising:
receiving a first signal using a first receive chain of a mobile device, wherein the first signal is received from a base station;
receiving a second signal using a second receive chain of the mobile device, wherein the second signal is received from a common, remote timing source for the base station and the mobile device;
obtaining a transmit delay parameter associated with the base station;
estimating, based at least in part on the transmit delay parameter, an offset value corresponding to a difference between amount of time for the first signal to pass through the first receive chain of the mobile device and amount of time for the second signal to pass through the second receive chain of the mobile device; and
storing the offset value for subsequent use in estimating position of the mobile device.

2. The method of claim 1, wherein the transmit delay parameter is determined by a first device and supplied to the mobile device, wherein an offset between time of arrival of signals from the first receive chain and the second receive chain is known for the first device.

3. The method of claim 1, further comprising:
measuring a time of arrival of the first signal;
obtaining a time of transmission of the first signal from the base station;
and wherein estimating the offset value comprises estimating the offset value based, at least in part, upon the time of arrival of the first signal, the time of transmission of the first signal from the base station, a time of propagation of the first signal from the base station, and the transmit delay parameter.

4. The method of claim 1, further comprising:
obtaining an estimated position of the mobile device; and
estimating the offset value based at least on the estimated position.

5. The method of claim 4, wherein the estimated position is based on communications with one or more wireless local area network base stations.

6. The method of claim 4, wherein the estimated position is derived using a Kalman filter.

7. The method of claim 1, further comprising:
communicating with an additional base station using the first receive chain to determine an additional transmit delay parameter corresponding to the additional base station based at least in part on the estimated offset value corresponding to the first receive chain; and
transmitting the additional transmit delay parameter.

8. The method of claim 7, wherein communicating with the additional base station comprises:
obtaining one or more measurements from the additional base station; and
determining the additional transmit delay parameter based on an average of the one or more measurements.

9. An apparatus for wireless communications comprising:
a first receive chain for receiving a first signal, wherein the first signal is received from a base station;
a second receive chain for receiving a second signal, wherein the second signal is received from a common, remote timing source for the base station and the apparatus;
a circuit for obtaining a transmit delay parameter associated with the base station;
an estimator for estimating, based at least in part on the transmit delay parameter, an offset value corresponding to a difference between amount of time for the first signal to pass through the first receive chain of the apparatus and amount of time for the second signal to pass through the second receive chain of the apparatus; and
a memory for storing the offset value for subsequent use in estimating position of the apparatus.

10. The apparatus of claim 9, wherein the transmit delay parameter is determined by a first device and supplied to the apparatus, wherein an offset between time of arrival of signals from the first receive chain and the second receive chain is known for the first device.

11. The apparatus of claim 9, further comprising:
a circuit for measuring a time of arrival of the first signal;
a circuit for obtaining a time of transmission of the first signal from the base station; and
wherein the offset value is further based, at least in part, upon the time of arrival of the first signal, the time of transmission of the first signal from the base station, a time of propagation of the first signal from the base station, and the transmit delay parameter.

12. The apparatus of claim 9, further comprising:
a circuit for obtaining an estimated position of the apparatus; and
an estimator for estimating the offset value based at least on the estimated position.

13. The apparatus of claim 12, wherein the estimated position is based on communications with one or more wireless local area network base stations.

14. The apparatus of claim 12, wherein the estimated position is derived using a Kalman filter.

15. The apparatus of claim 9, wherein the first receive chain further communicates with an additional base station to determine an additional transmit delay parameter corresponding to the additional base station based at least in part on the estimated offset value corresponding to the first receive chain; and
the apparatus further comprises a transmitter for transmitting the additional transmit delay parameter.

16. The apparatus of claim 15, wherein the first receive chain further comprises:
a circuit for obtaining one or more measurements from the additional base station; and
a circuit for determining the additional transmit delay parameter based on an average of the one or more measurements.

17. An apparatus for wireless communications comprising:
a first means for receiving a first signal, wherein the first signal is received from a base station;
a second means for receiving a second signal, wherein the second signal is received from a common, remote timing source for the base station and the apparatus;
means for obtaining a transmit delay parameter associated with the base station;
means for estimating, based at least in part on the transmit delay parameter, an offset value corresponding to a difference between amount of time for the first signal to pass through the first receive chain and amount of time for the second signal to pass through the second receive chain; and
means for storing the offset value for subsequent use in estimating position of the apparatus.

18. The apparatus of claim 17, wherein the transmit delay parameter is determined by a first device and supplied to the apparatus, wherein an offset between time of arrival of signals from the first means and the second means is known for the first device.

19. The apparatus of claim 17, further comprising:
means for measuring a time of arrival of the first signal;
means for obtaining a time of transmission of the first signal from the base station; and
wherein the offset value is further based, at least in part, upon the time of arrival of the first signal, the time of transmission of the first signal from the base station, a time of propagation of the first signal from the base station, and the transmit delay parameter.

20. The apparatus of claim 17, further comprising:
means for obtaining an estimated position of the apparatus; and
means for estimating the offset value based at least on the estimated position.
